(19) United States
(12) Patent Application Publication
(10) Pub. No.: US 2010/0020464 A1
(43) Pub. Date: Jan. 28, 2010

(54) MULTILAYER CERAMIC ELECTRONIC COMPONENT AND METHOD FOR PRODUCING SAME

(75) Inventors: Toshiyuki IWANAGA, Sabae-shi (JP); Akihiro MOTOKI, Fukui-shi (JP); Makoto OGAWA, Fukui-shi (JP); Kenichi KAWASAKI, Echizen-shi (JP); Shunsuke TAKEUCHI, Echizen-shi (JP); Seiichi NISHIHARA, Kameoka-shi (JP); Shuji MATSUMOTO, Omihachiman-shi (JP)

Correspondence Address: MURATA MANUFACTURING COMPANY, LTD.;C/O KEATING & BENNETT, LLP, 1800 Alexander Bell Drive, SUITE 200, Reston, VA, 20191, US

(73) Assignee: MURATA MANUFACTURING CO., LTD., Nagaokakyo-shi (JP)

(21) Appl. No.: 12/405,372

(22) Filed: Mar. 17, 2009

(30) Foreign Application Priority Data
Jul. 28, 2008 (JP) 2008-193752

(51) Int. Cl. H01G 4/30

(52) U.S. Cl. 361/301.4; 29/25.42

(57) ABSTRACT

A method for producing a multilayer ceramic electronic component includes a plating step including depositing a plating material on the ends of internal electrodes exposed at a predetermined surface of a laminate to form plating deposits primarily composed of a specific metal and growing the plating deposits so as to connect the plating deposits to each other to form a continuous plated layer. The specific metal primarily defining the plated layer is different from a metal defining the internal electrodes. The same or substantially the same metal as the metal defining the internal electrodes is present throughout the plated layer.

### BACKGROUND OF THE INVENTION

1. Field of the Invention

The present invention relates to a multilayer ceramic electronic component and a method for producing the component. In particular, the present invention relates to a multilayer ceramic electronic component having an external electrode directly formed on an outer surface of a laminate by plating and a method for producing the component.

2. Description of the Related Art

Referring to FIG. 4, a multilayer ceramic electronic component 101, such as a multilayer ceramic capacitor, includes a laminate 102 having a plurality of stacked ceramic layers 103 and a plurality of layered internal electrodes 104 and 105 arranged along interfaces between the ceramic layers 103. An end of each of the internal electrodes 104 is exposed at one end surface 106 of the laminate 102. An end of each of the internal electrodes 105 is exposed at the other end surface 107 of the laminate 102. External electrodes are each arranged such that the ends of the internal electrodes 104 or the internal electrodes 105 are electrically connected to each other.

To form the external electrodes, a metal paste including a metal component and a glass component is applied on the end surfaces 106 and 107 and then baked to form paste electrode layers 108 and 109. First plated layers 110 and 111 primarily composed of, for example, Ni are then formed on the paste electrode layers 108 and 109, respectively. Second plated layers 112 and 113 primarily composed of, for example, Sn are formed thereon. That is, the external electrodes each have three-layer structure including the paste electrode layer 108 or 109, the first plated layer 110 or 111, and the second plated layer 112 or 113.

When the multilayer ceramic electronic component 101 is mounted on a substrate, the external electrodes must have satisfactory solder wettability. Furthermore, the external electrodes must be able to electrically connect the plurality of internal electrodes, which are electrically insulated from each other, to each other. The second plated layers 112 and 113 ensure solder wettability. The paste electrode layers 108 and 109 electrically connect the internal electrodes 104 and 105 to each other. The first plated layers 110 and 111 prevent solder leaching.

However, each of the paste electrode layers 108 and 109 has a thickness of several tens to several hundreds of micrometers. To achieve dimensions of the multilayer ceramic electronic component 101 within specifications, the effective volume for ensuring capacitance must be reduced by the volume of the paste electrode layers. The first plated layers 110 and 111 and the second plated layers 112 and 113 each have a thickness of about several micrometers. Thus, if the external electrodes can be formed of only the plated layers, a larger effective volume to ensure capacitance can be provided.

For example, Japanese Unexamined Patent Application Publication No. 63-169014 discloses a method for forming conductive metal layers by electroless plating on the entire side surfaces of a laminate at which internal electrodes are exposed such that the internal electrodes exposed at each of the side surfaces are electrically connected.

An example of the multilayer ceramic electronic component described in Japanese Unexamined Patent Application Publication No. 63-169014 is a multilayer ceramic capacitor produced by directly forming layers by plating on surfaces of a laminate at which internal electrodes are exposed.

However, in the method described in Japanese Unexamined Patent Application Publication No. 63-169014, since the surfaces at which the internal electrodes are exposed are directly subjected to plating, a plating solution easily permeates into the laminate. Where heat treatment is performed at about 600° C. or higher after plating in order to remove water of the plating solution, components of the internal electrodes may significantly diffuse toward the resulting plated layers, causing breaks in the internal electrodes. In such a case, a faulty connection between the internal electrodes and the external electrodes disadvantageously reduces the capacitance.

### SUMMARY OF THE INVENTION

To overcome the problems described above, preferred embodiments of the present invention provide a multilayer ceramic electronic component and a method for producing a multilayer ceramic electronic component.

A preferred embodiment of the present invention is directed to a method for producing a multilayer ceramic electronic component including the steps of preparing a laminate including a plurality of stacked ceramic layers and a plurality of internal electrodes arranged between the ceramic layers, an end of each of the internal electrodes being exposed at a predetermined surface, and forming a plated layer on the predetermined surface such that the ends of the plurality of internal electrodes exposed at the predetermined surface of the laminate are electrically connected to each other.

According to a preferred embodiment of the present invention, in order to overcome the technical problems described above, the step of forming the plated layer includes a plating substep of performing plating. The plating substep includes the subsubsteps of depositing a plating material on the ends of the plurality of internal electrodes exposed at the predetermined surface of the laminate to form plating deposits primarily composed of a specific metal and growing the plating deposits so as to connect the plating deposits to each other to form the continuous plated layer, in which the diffusion coefficient of a metal defining the internal electrodes is greater than that of the specific metal primarily defining the plated layer. Furthermore, the same or substantially the same metal as the metal defining the internal electrodes is present throughout the plated layer.

To form the plated layer primarily composed of the specific metal and including the same or substantially the same metal as the metal defining the internal electrodes in the plating substep, the plating substep is preferably performed in a plating bath including one of ions, a complex of the specific metal and including ions, or a complex of the same or substantially the same metal as the metal defining the internal electrodes. Alternatively, the plating substep is also preferably performed in a plating bath including one of ions or a complex of the specific metal and including particles of the same or substantially the same metal as the metal defining the internal electrodes, the particles being dispersed in the plating bath.

More preferably, the specific metal is Ni, and the metal defining the internal electrodes is Cu.

According to a preferred embodiment of the present invention, the step of forming the plated layer includes a first plating substep of performing plating, the first plating substep including the subsubsteps of depositing a plating material on the ends of the plurality of internal electrodes exposed on the predetermined surface of the laminate to form plating deposits primarily composed of a specific metal, and growing the resulting plating deposits so as to connect the plating deposits to each other, so that a continuous first plated sublayer is formed, a second plating substep of forming a second plated sublayer primarily composed of the same or substantially the same metal as a metal defining the internal electrodes, and a heating substep of performing heat treatment at about 600° C. or higher after the second plating substep, in which the diffusion coefficient of the metal defining the internal electrodes is greater than that of the specific metal primarily defining the plated layer. In this case, more preferably, the first plating sublayer primarily composed of the specific metal preferably has an average thickness of about 10 μm or less, for example.

A multilayer ceramic electronic component produced by the method for producing a multilayer ceramic electronic component according to a preferred embodiment of the present invention also has unique structural features. That is, preferred embodiments of the present invention is directed to a multilayer ceramic electronic component including a laminate having a plurality of stacked ceramic layers and a plurality of internal electrodes arranged along interfaces between the ceramic layers, an end of each of the internal electrodes being exposed at a predetermined surface, and a plated layer directly arranged on the predetermined surface of the laminate.

According to a preferred embodiment of the present invention, the diffusion coefficient of a metal defining the internal electrodes is greater than that of the specific metal primarily defining the plated layer. Furthermore, the same or substantially the same metal as the metal defining the internal electrodes is present throughout the plated layer.

According to a preferred embodiment of the present invention, a plated layer primarily composed of the same or substantially the same metal as the metal defining the internal electrodes is also preferably arranged on the plated layer. In this case, more preferably, the plated layer primarily composed of the specific metal preferably has an average thickness of about 10 μm or less, for example.

In the method for producing a multilayer ceramic electronic component according to a preferred embodiment of the present invention, the same or substantially the same metal as the component defining the internal electrodes is uniformly distributed in the plated layer directly formed on the surface at which the internal electrodes are exposed. This suppresses the diffusion of the highly diffusible metal component defining the internal electrodes during heat treatment, which prevents defects or breaks in the internal electrodes near the surface at which the internal electrodes are exposed and prevents a reduction in capacitance.

In particular, where the plated layer is primarily composed of Ni, and the plated layer includes Cu, and the internal electrodes are primarily composed of Cu, the Cu present in the plated layer effectively prevents migration of Cu of the internal electrodes, which is readily diffusible, in the internal electrodes, thereby preventing defects or breaks in the internal electrodes.

Furthermore, the heat treatment enhances the adhesion between the internal electrodes exposed at the end surface and the ceramic layers. This effectively prevents permeation of water into the laminate, thus ensuring high reliability.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a cross-sectional view of a multilayer ceramic electronic component according to a first preferred embodiment of the present invention.

FIG. 2 is an enlarged fragmentary cross-sectional view of a laminate shown in FIG. 1.

FIG. 3 is a cross-sectional view of a multilayer ceramic electronic component according to a second preferred embodiment of the present invention.

FIG. 4 is a cross-sectional view of a multilayer ceramic electronic component according to the related art.

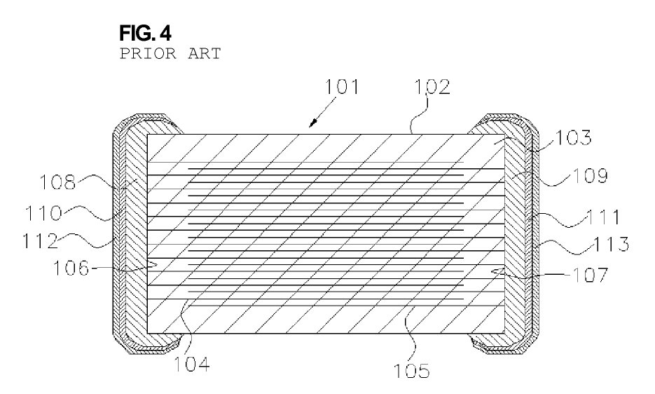

### DETAILED DESCRIPTION OF PREFERRED EMBODIMENTS

### First Preferred Embodiment

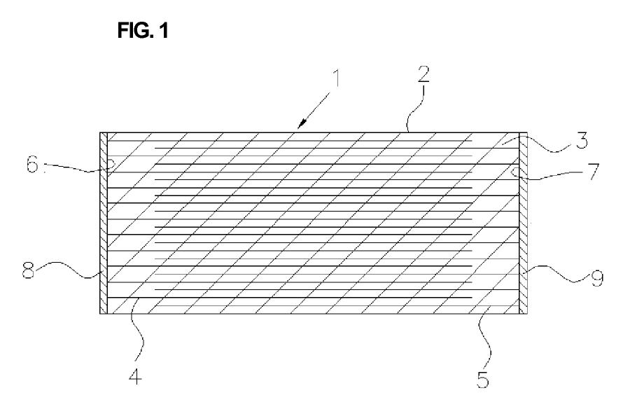

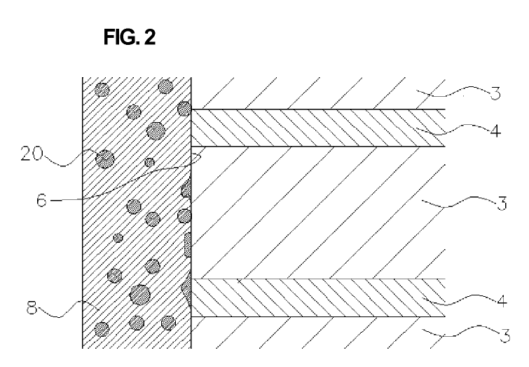

A multilayer ceramic electronic component 1 and a method for producing the multilayer ceramic electronic component 1 according to a first preferred embodiment of the present invention will be described below with reference to FIGS. 1 and 2.

As shown in FIG. 1 which is a cross-sectional view, the multilayer ceramic electronic component 1 includes a laminate 2 having a plurality of stacked ceramic layers 3 and a plurality of layered internal electrodes 4 and 5 arranged along interfaces between the ceramic layers 3. Where the multilayer ceramic electronic component 1 is a multilayer ceramic electronic component, the ceramic layers 3 are composed of a dielectric ceramic material. An end of each of the plurality of internal electrodes 4 is exposed at one end surface 6 of the laminate 2. An end of each of the plurality of internal electrodes 5 is exposed at the other end surface 7. External electrodes are each arranged such that the ends of the internal electrodes 5 or the internal electrodes 5 are electrically connected with each other.

The external electrodes include first plated layers 8 and 9 composed of plating deposits formed by wet plating. The first plated layers 8 and 9 are directly electrically connected to the internal electrodes 4 and 5, respectively. That is, the first plated layers 8 and 9 do not include conductive paste films or films formed by, for example, vacuum evaporation or sputtering.

With respect to the method for producing the multilayer ceramic electronic component 1 shown in FIG. 1, in particular, a process of forming the first plated layers 8 and 9 into which a component defining the internal electrodes diffuses readily will be described also with reference to FIG. 2.

FIG. 2 is a fragmentary view of the laminate 2 shown in FIG. 1 and an enlarged view of a portion including the end surface 6 at which the internal electrodes 4 are exposed. A structure including the end surface 7 and the exposed internal electrodes 5 is substantially the same as the structure including the end surface 6 and the internal electrodes 4 described above.

The laminate 2 is first prepared, the laminate 2 including the plurality of stacked the ceramic layers 3 and the plurality of internal electrodes 4 and 5 arranged along the interfaces between the ceramic layers 3, an end of each internal electrodes 4 being exposed at the end surface 6, and an end of each internal electrodes 5 being exposed at the end surface 7. In the laminate 2, when the ends of the internal electrodes 4 and 5 are spaced inwardly from the end surfaces 6 and 7 and are not sufficiently exposed, the ceramic layers 3 are preferably ground by sand blasting or barrel polishing, for example, to adequately expose the internal electrodes 4 and 5 at the end surfaces 6 and 7.

A step of forming the first plated layers 8 and 9 on the end surfaces 6 and 7 of the laminate 2 is performed so as to electrically connect the ends of the internal electrodes 4 exposed at the end surface 6 to each other and so as to electrically connect the ends of the internal electrodes 5 exposed at the end surface 7 to each other.

In the step of forming the first plated layers 8 and 9, a plating substep of performing plating is conducted. The plating substep includes the subsubsteps of depositing a plating material on the ends of the plurality of internal electrodes 4 and 5 exposed at the end surfaces 6 and 7 of the laminate 2 and growing the plating deposits so as to connect the plating deposits to each other, such that the continuous plated layers 8 and 9 are directly formed on the end surfaces 6 and 7.

Referring to FIG. 2 which is an enlarged view of the component shown in FIG. 1, the same or substantially the same metal component 20 as the metal defining the internal electrodes are dispersed throughout the first plated layer 8. In FIG. 2, the metal component 20 is locally present to a certain degree. Alternatively, for example, an alloy in which the metal component 20 is more uniformly dispersed may be used. The first plated layer 8 preferably includes a metal component 20 content of about 0.5% to about 50% by weight, and more preferably of about 5% to about 20% by weight, for example.

When the first plated layer 8 is primarily composed of metallic nickel and when Cu, which is the same or substantially the same component defining the internal electrodes, is present in the first plated layer 8, Cu in the plated layer more effectively prevents migration of Cu from the internal electrodes to the plated layer during heat treatment. That is, the readily diffusible Cu component in the internal electrode is prevented from diffusing into the plated layer primarily composed of Ni, thereby reducing breaks in the Cu internal electrodes.

Although this combination of the main metal component of the first plated layer 8 and the metal defining the internal electrodes is the most preferable combination, another combination may be used as long as the effects of the present invention are not impaired.

A process for forming the first plated layers 8 and 9 according to the first preferred embodiment of the present invention will be described below.

The plating substep is preferably performed, for example, by immersing a vessel including a laminate and a mixing medium in a plating bath including ions or a complex of a plating metal and passing a current therethrough. For example, the plating substep may preferably be performed by electrolytic or electroless barrel plating using a rotary barrel as the vessel.

To form the first plated layers 8 and 9 including the metal component 20 that defines the metal component 20, the plating substep may be performed in a plating bath including ions or a complex of the metal that is a main component of the first plated layer 8 and including ions or a complex of the same or substantially the same metal as the metal defining the internal electrodes. In this case, both the metal that is the main component of the first plated layer 8 and the same or substantially the same metal as the metal defining the internal electrodes are deposited on the exposed ends of the internal electrodes 4 and 5 and then grown to form the continuous first plated layers 8 and 9. This process is referred to as “alloy plating” and has the advantage that the plated layer can be easily modified only by changing the components in the plating bath.

Alternatively, in order to form the first plated layers 8 and 9 including the metal component 20 that defines the metal component 20, the plating substep may be performed in a plating bath including particles of the same or substantially the same metal as the metal defining the internal electrodes, the particles being dispersed in the plating bath. In this case, when the metal that is the main component of the first plated layers is deposited by plating, the foregoing metal particles located near the ends of the internal electrodes are simultaneously incorporated, thereby forming the first plated layers 8 and 9 including a large number of the metal particles. This process is referred to as a “eutectic process” and has the advantages that the deposition control is facilitated because a single metal component is deposited by plating.

When the first plated layers 8 and 9 are composed of Ni, plated layers composed of Sn or Au may be formed thereon in order to ensure solder wettability.

### Second Preferred Embodiment

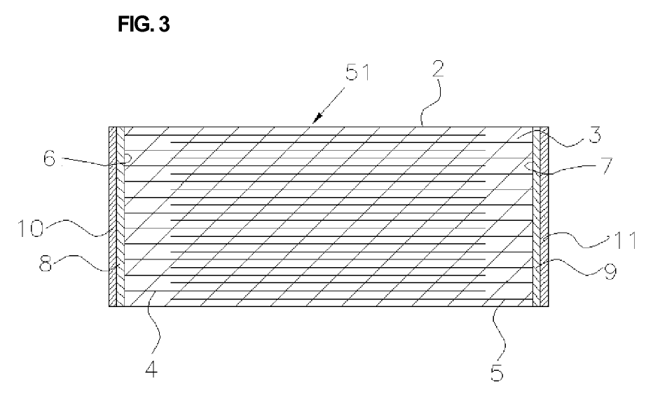

A multilayer ceramic electronic component 51 and a method for producing the same according to a second preferred embodiment of the present invention will be described below with reference to a cross-sectional view of FIG. 3.

The same laminate 2 as in the first preferred embodiment is prepared. The first plated layers 8 and 9 composed of a metal different from the metal defining the internal electrodes are formed on the end surfaces 6 and 7 of the laminate 2 at which the internal electrodes 4 and 5 are exposed in the same manner as in the first preferred embodiment.

In the second preferred embodiment, second plated layers 10 and 11 primarily composed of the same or substantially the same metal as that defining the internal electrodes 4 and 5 are formed on the first plated layers 8 and 9 and then a heat treatment is performed at about 600° C. or higher. A certain amount of the same or substantially the same metal component as that defining the internal electrodes 4 and 5 diffuses from the second plated layers 10 and 11 into the first plated layers 8 and 9 during heat treatment, resulting in the first plated layers 8 and 9 including the same or substantially the same metal component as that defining the internal electrodes as in the first preferred embodiment. This prevents diffusion of the component from the internal electrodes 4 and 5 into the first plated layers 8 and 9. The heat treatment at about 600° C. must not be performed between the formation of the first plated layers and the formation of the second plated layers.

In the second preferred embodiment, a smaller thickness of each of the first plated layers 8 and 9 permits the component that migrates from the second plated layers 10 and 11 to diffuse more readily throughout the first plated layers 8 and 9, thereby effectively preventing diffusion of the metal primarily defining the first plated layers into the internal electrodes. Each of the first plated layers 8 and 9 preferably has an average thickness of about 10 μm or less.

The combination of the main component, Ni, of the first plated layers 8 and 9 and the main component, Cu, of the second plated layers 10 and 11, i.e., the main component of the internal electrodes, is preferred as in the first embodiment.

Unlike the first preferred embodiment, in the method according to the second preferred embodiment, the same or substantially the same metal as that defining the internal electrodes is not present in the first plated layers 8 and 9 before the heat treatment. The metal component diffuses from the second plated layers into the first plated layers during the heat treatment at about 600° C. Thus, in this method according to the second preferred embodiment, if each of the first plated layers 8 and 9 has a relatively large thickness, the diffusion of the component from the second plated layers 10 and 11 is relatively slow, thereby disadvantageously reducing the effect of the present invention.

However, the method according to the second preferred embodiment has the advantages that it is simpler than the method according to the first preferred embodiment because the alloy plating and the eutectic method used in the first preferred embodiment are not required for the second preferred embodiment.

When the second plated layers 10 and 11 are composed of Cu, Ni plated layers to prevent solder leaching and plated layers composed of Sn or Au to ensure solder wettability may be formed, in that order, thereon.

Points that are common to the first and second preferred embodiments will be described below.

The process of forming the first plated layers 8 and 9 utilizes high growing strength and malleability of the plating deposits. Where the distance between adjacent internal electrodes is preferably about 10 μm or less when the plated layers are formed by electrolytic plating and preferably about 20 μm or less when the plated layers are formed by electroless plating.

The distance between each end surface at which a corresponding one of the internal electrodes 4 and 5 is exposed and the corresponding ends of the internal electrodes 4 and 5, each of the ends being located inside the laminate, is preferably about 1 μm or less, for example, before the formation of the first plated layers 8 and 9. This is because a distance exceeding about 1 μm inhibits the feeding of electrons into the exposed portions of the internal electrodes 4, thereby inhibiting the deposition of the plating material. To reduce the distance, polishing such as sand blasting or barrel polishing may preferably be performed, for example.

Alternatively, the ends of the internal electrodes preferably protrude from the surfaces at which the internal electrodes 4 and 5 are exposed before plating. This can be accomplished by appropriately controlling conditions of polishing, such as sand blasting, for example. The protruded portions of the internal electrodes 4 and 5 extend parallel or substantially parallel to the surfaces to be subjected to plating during polishing. This results in a reduction in growth length necessary to connect plating deposits formed on adjacent ends of the internal electrodes to each other. In this case, the distance between adjacent internal electrodes is preferably about 20 μm or less, for example, when the plated layers are formed by electrolytic plating and preferably about 50 μm or less, for example, when the plated layers are formed by electroless plating because the grown plating deposits are easily connected to each other.

External electrodes of a ceramic electronic component according to preferred embodiments of the present invention are substantially formed of plated layers. Paste electrodes may be formed at portions that do not participate directly in the connection of the plurality of internal electrodes. For example, in order to extend each external electrode to surfaces adjacent to a corresponding one of the end surfaces of the internal electrodes, thick-film paste electrodes may be formed. In this case, mounting via soldering can be facilitated. Furthermore, the permeation of water from the edges of the plated layers can be effectively prevented. The heat treatment at about 600° C. or higher also bakes for the paste electrodes, which is efficient.

While the present invention has been described with reference to the preferred embodiments shown in the drawings, various changes can be made within the scope of the invention.

For example, a multilayer ceramic electronic component to which preferred embodiments of the present invention can be applied is exemplified by a multilayer chip capacitor. In addition, preferred embodiments of the present invention can also preferably be applied to a multilayer chip inductor and a multilayer chip thermistor, for example.

The ceramic layers included in the multilayer ceramic electronic component therefore may have electrical insulation properties and may be composed of any suitable material. That is, the material defining the ceramic layers is not limited to a dielectric ceramic material but may also be a piezoelectric ceramic material, a semiconductor ceramic material, and a magnetic ceramic material, for example.

Although the multilayer ceramic electronic component having two external electrodes is exemplified in FIG. 1, many external electrodes may be arranged. An example thereof is an array-type component including a plurality of external electrodes.

Experimental Examples performed in order to determine the effects of the preferred embodiments of the present invention will be described below.

### Experimental Example 1

Laminates each having a length of about 1.9 mm, a width of about 1.05 mm, and a height of about 1.05 mm for multilayer ceramic capacitors were prepared as laminates of multilayer ceramic electronic components to be samples, each of the laminates having ceramic layers composed of a barium titanate-based dielectric ceramic material and having internal electrodes mainly composed of Cu. In each laminate, each of the ceramic layers had a thickness of about 2.0 μm. The distance between adjacent internal electrodes exposed at surfaces of each laminate was about 4.0 μm.

About 500 pieces of the laminates were placed in a horizontal rotary barrel having a capacity of about 290 mL. Conductive media having a diameter of about 1.3 mm were also placed therein in an amount of about 100 mL. The rotary barrel was immersed in a Ni/Cu-alloy-plating bath having a pH of about 8.7 and a bath temperature of about 25° C. A current was passed therethrough at a current density of about 0.50 A/dm² for a predetermined period of time while the barrel was being rotated at a peripheral speed of about 2.6 m/min, thereby forming first plated layers each having a thickness of about 4 μm and mainly composed of a Ni/Cu alloy. The composition of the Ni/Cu-plating bath is shown below.
Nickel pyrophosphate: about 15 g/L
Copper pyrophosphate: about 5 g/L
Pyrophosphoric acid: about 120 g/L
Potassium oxalate: about 10 g/L

Then the laminates were taken out from the barrel and dried to provide samples of the multilayer ceramic capacitors.

After the capacitance of about 100 samples was measured, the samples were subjected to heat treatment in an atmosphere having an oxygen concentration of about 5 ppm or less and a temperature of about 820° C. The In-Out time was about 30 minutes. The holding period was about 270 seconds at about 820° C.

The capacitance of the samples was measured again. The rate of reduction in capacitance was determined with respect to the capacitance before the heat treatment. A sample having a rate of reduction of at least about 5% was regarded as a sample in which the electrodes were severely broken during heat treatment, and was referred to as “Failure 1”.

Only the non-defective samples obtained after the foregoing test were subjected to a rapid spark test in which immediately after a rated voltage of about 6.3 V was applied to the samples, the samples were short-circuited. The capacitance of the samples was measured. The rate of reduction in capacitance was determined with respect to the capacitance before the heat treatment. A sample having a rate of reduction of at least about 5% was regarded as a sample in which its electrodes were broken to a certain degree during heat treatment, and was referred to as “Failure 2”. The total number of Failures 1 and 2 was defined as the number of failures regarding breaks in the internal electrodes.

For about 100 samples prepared in this Experimental Example, the number of failures regarding breaks in the internal electrodes was zero.

### Experimental Example 2

The same laminates as those used in Experimental Example 1 were prepared as laminates of multilayer ceramic electronic components to be samples.

About 500 pieces of the laminates were placed in a horizontal rotary barrel having a capacity of about 290 mL. Conductive media having a diameter of about 1.3 mm were also placed therein in an amount of about 100 mL.

Metallic Cu particles having an average particle size of about 0.5 μm were added to a Watts bath, for Ni plating, having a pH of about 4.0 and a temperature of about 55° C. n such that the concentration of the Cu particles was about 7 g/L. The mixture was stirred to prepare a Ni-plating bath including the Cu particles dispersed therein.

A rotary barrel was immersed in the Ni-plating bath. A current was passed therethrough at a current density of about 0.15 A/dm² for a predetermined period of time while the barrel was being rotated at a peripheral speed of about 2.6 m/min, thereby forming first plated layers each having a thickness of about 4 μm, primarily composed of Ni, and including the metallic Cu particles.

Then the laminates were taken out from the barrel and subjected to heat treatment under the same conditions as in Experimental Example 1, thereby providing samples of the multilayer ceramic capacitors.

For about 100 samples of the multilayer ceramic capacitors, the number of failures regarding breaks in the internal electrodes was determined as in Experimental Example 1 and was zero.

### Experimental Example 3

The same laminates as those used in Experimental Example 1 were prepared as laminates of multilayer ceramic electronic components to be samples.

About 500 pieces of the laminates were placed in a horizontal rotary barrel having a capacity of about 290 mL. Conductive media having a diameter of about 1.3 mm were also placed therein in an amount of about 100 mL. The rotary barrel was immersed in a Watts bath, for Ni plating, having a pH of about 4.0 and a temperature of about 55° C. A current was passed therethrough at a current density of about 0.15 A/dm² for a predetermined period of time while the barrel was being rotated at a peripheral speed of about 2.6 m/min, thereby forming a first plated layer having a thickness of about 2 μm and primarily composed of Ni.

After the rotary barrel including the laminates was washed with water, the resulting rotary barrel was immersed in a Cu-plating bath having a pH of about 8.7 and a bath temperature of about 25° C. A current was passed therethrough at a current density of about 0.50 A/dm² for a predetermined period of time while the barrel was being rotated at a peripheral speed of about 2.6 m/min, thereby forming second plated layers each having a thickness of about 2 μm and primarily composed of Cu. The composition of the Cu-plating bath is shown below.
Copper pyrophosphate: about 15 g/L
Pyrophosphoric acid: about 120 g/L
Potassium oxalate: about 10 g/L

Then the laminates were taken out from the barrel and subjected to heat treatment under the same conditions as in Experimental Example 1, thereby affording samples of the multilayer ceramic capacitors.

For about 100 samples of the multilayer ceramic capacitors, the number of failures regarding breaks in the internal electrodes was determined as in Experimental Example 1 and was zero.

### Comparative Example

The same laminates as those used in Experimental Example 1 were prepared as laminates of multilayer ceramic electronic components to be samples.

About 500 pieces of the laminates were placed in a horizontal rotary barrel having a capacity of about 290 mL. Conductive media having a diameter of about 1.3 mm were also placed therein in an amount of about 100 mL. The rotary barrel was immersed in a Watts bath, for Ni plating, having a pH of about 4.0 and a temperature of about 55° C. A current was passed therethrough at a current density of about 0.15 A/dm² for a predetermined period of time while the barrel was being rotated at a peripheral speed of about 2.6 m/min, thereby forming a first plated layer having a thickness of about 2 μm and primarily composed of Ni.

Then the laminates were taken out from the barrel and subjected to heat treatment under the same conditions as in Experimental Example 1, thereby providing samples of the multilayer ceramic capacitors.

For about 100 samples of the multilayer ceramic capacitors, the number of failures regarding breaks in the internal electrodes was determined as in Experimental Example 1. As a result, all samples were determined to be Failure 1.

While preferred embodiments of the invention have been described above, it is to be understood that variations and modifications will be apparent to those skilled in the art without departing the scope and spirit of the invention. The scope of the invention, therefore, is to be determined solely by the following claims.

What is claimed is:

1. A method for producing a multilayer ceramic electronic component, comprising the steps of:
preparing a laminate including a plurality of stacked ceramic layers and a plurality of internal electrodes arranged along interfaces between the ceramic layers, an end of each of the internal electrodes being exposed at a predetermined surface; and
forming a plated layer on the predetermined surface such that the ends of the plurality of internal electrodes exposed at the predetermined surface of the laminate are electrically connected to each other; wherein
the step of forming the plated layer includes:
a plating substep of performing plating including the steps of:
depositing a plating material on the ends of the plurality of internal electrodes exposed at the predetermined surface of the laminate to form plating deposits mainly composed of a specific metal; and
growing the plating deposits so as to connect the plating deposits to each other to form the continuous plated layer;
a diffusion coefficient of a metal defining the internal electrodes is greater than that of the specific metal primarily defining the plated layer; and
the same or substantially the same metal as the metal defining the internal electrodes is present throughout the plated layer.

2. The method according to claim 1, wherein the plating substep is performed in a plating bath including one of ions, a complex of the specific metal and including ions, or a complex of the same or substantially the same metal as the metal defining the internal electrodes.

3. The method according to claim 1, wherein the plating substep is performed in a plating bath including one of ions or a complex of the specific metal and including particles of the same or substantially the same metal as the metal defining the internal electrodes, the particles being dispersed in the plating bath.

4. The method according to claim 1, wherein the specific metal is Ni, and the metal defining the internal electrodes is Cu.

5. A method for producing a multilayer ceramic electronic component, comprising the steps of:
preparing a laminate including a plurality of stacked ceramic layers and a plurality of internal electrodes arranged along interfaces between the ceramic layers, an end of each of the internal electrodes being exposed at a predetermined surface; and
forming a plated layer on the predetermined surface such that the ends of the plurality of internal electrodes exposed at the predetermined surface of the laminate are electrically connected to each other;
the step of forming the plated layer includes:
a first plating substep of performing plating including the steps of:
depositing a plating material on the ends of the plurality of internal electrodes exposed on the predetermined surface of the laminate to form plating deposits primarily composed of a specific metal; and
growing the resulting plating deposits so as to connect the plating deposits to each other, so that a continuous first plating sublayer is formed;
a second plating substep of forming a second plating sublayer primarily composed of the same or substantially the same metal as a metal defining the internal electrodes; and
a heating substep of performing heat treatment at about 600° C. or higher after the second plating substep;
a diffusion coefficient of the metal defining the internal electrodes is greater than that of the specific metal primarily defining the plated layer.

6. The method according to claim 5, wherein the first plating sublayer mainly composed of the specific metal has an average thickness of about 10 μm or less.

7. The method according to claim 5, wherein the specific metal is Ni, and the metal defining the internal electrodes is Cu.

8. A multilayer ceramic electronic component comprising:
a laminate including a plurality of stacked ceramic layers and a plurality of internal electrodes arranged along interfaces between the ceramic layers, an end of each of the internal electrodes being exposed at a predetermined surface; and
a plated layer directly arranged on the predetermined surface of the laminate; wherein
a diffusion coefficient of a metal defining the internal electrodes is greater than that of the specific metal primarily defining the plated layer; and
the same or substantially the same metal as the metal defining the internal electrodes is present throughout the plated layer.

9. The multilayer ceramic electronic component according to claim 8, wherein a plated layer primarily composed of the same or substantially the same metal as the metal defining the internal electrodes is arranged on the plated layer.

10. The multilayer ceramic electronic component according to claim 9, wherein the plated layer primarily composed of the specific metal has an average thickness of about 10 μm or less.

11. The multilayer ceramic electronic component according to claim 8, wherein the specific metal is Ni, and the metal defining the internal electrodes is Cu.
